(19) United States
(12) Patent Application Publication
(10) Pub. No.: US 2026/0340195 A1
(43) Pub. Date: Oct. 29, 2026

(54) HARDWARE-ATTESTED VERIFIED PREDICTION CONFIDENCE SCORING SYSTEM

(71) Applicant: George William Bickerstaff`, III, Greenwich, CT (US)

(72) Inventor: George William Bickerstaff`, III, Greenwich, CT (US)

(21) Appl. No.: 19/714,104

(22) Filed: Jun. 19, 2026

(51) Int. Cl. G06F 21/64; G06F 21/62; H04L 9/32

(52) U.S. Cl. CPC G06F 21/64; G06F 21/6254; H04L 9/3218; H04L 9/3247

(57) ABSTRACT

A hardware-attested system computes a signal-weighted probability estimate and a calibrated insider-risk indicator for prediction market contracts within a trusted execution environment. The system ingests participant position and pseudonymized identity records and receives raw trade-integrity signals as attested input from a companion detection system, which the scoring system consumes but does not generate. A participant-profiling module maintains sealed historical accuracy profiles from decay-weighted Brier scores, a conviction-weighting module computes capital-weighted conviction, and an insider-risk module computes a calibrated insider-risk indicator at a configured z-score threshold from the received signals and anomalous-accuracy patterns. A scoring module aggregates these into a probability estimate that downweights flagged participants. An attestation module produces a hardware-attestation quote binding the estimate, the indicator, and commitments over inputs and parameters, independently verifiable by a relying party against a hardware-vendor attestation service without reliance on the exchange operator.

### CROSS-REFERENCE TO RELATED APPLICATIONS

This application claims the benefit of U.S. Provisional Application No. 64/044,023, filed Apr. 20, 2026, the entire contents of which are incorporated herein by reference. This application is related to commonly-owned co-pending applications directed to companion systems including a hardware-attested trade integrity system (HATIS), a regulatory-compliant wrapper system (RCW), a federated stack orchestrator (FSO), a multi-exchange consolidated platform (MECP), and a resolution-outcome oracle (Oracle Resolution), the contents of which are incorporated herein by reference to the extent consistent herewith.

### FIELD OF THE INVENTION

The present invention relates to regulated financial market infrastructure, and more particularly to a hardware-attested system that computes a signal-weighted probability estimate and a calibrated insider-risk indicator for prediction market contracts within a hardware trusted execution environment, consuming raw trade-integrity signals from a companion detection system and producing an independently verifiable scoring output.

### BACKGROUND OF THE INVENTION

Aggregating participant positions into a probability estimate for a prediction market contract is of limited value to an institutional consumer unless the estimate accounts for participant skill, conviction, and the risk that informed or coordinated participants are distorting the market. Detecting raw trade-integrity violations is a distinct technical function from calibrating those detections, together with participant accuracy and conviction, into a defensible probability estimate and insider-risk score.

A software-only scoring system affords a relying party no cryptographic means of confirming that the probability estimate and insider-risk indicator were computed under the stated methodology, on unaltered inputs, by unmodified code, without exposing the underlying participant data. A clear need exists for a hardware-attested scoring system that consumes raw trade-integrity signals from a companion detection system, computes a calibrated insider-risk indicator and a signal-weighted probability estimate within a hardware-protected enclave, and produces an attestation that a regulator or institutional consumer can verify independently of the exchange operator. The present invention addresses this need.

### SUMMARY OF THE INVENTION

The invention is directed to a hardware-attested verified prediction confidence scoring system comprising a scoring engine, an intake interface, a participant-profiling module, a conviction-weighting module, an insider-risk module, a scoring module, and an attestation module, each executing within a hardware trusted execution environment (TEE).

In one aspect, the system ingests participant position records, participant-identity records, and raw trade-integrity signals received as attested input from a companion HATIS detection system; maintains sealed historical accuracy profiles computed as higher-is-better transforms of decay-weighted Brier scores; computes capital-weighted conviction scores; computes a calibrated insider-risk indicator at a configured z-score threshold from the received raw trade-integrity signals and anomalous-accuracy patterns; aggregates these into a signal-weighted probability estimate that downweights flagged participants; and produces a hardware-attestation quote binding the estimate, the indicator, and commitments over inputs and parameters to the hardware measurement register.

Consistent with the companion-system architecture, the scoring system occupies the scoring side of a detection/scoring division of function: the companion HATIS system generates the raw trade-integrity signals and account-linkage fingerprints by detection, and the present scoring system computes the calibrated insider-risk indicator therefrom. The scoring system does not generate the raw trade-integrity signals; the companion detection system does not compute the calibrated insider-risk indicator. The signal-weighted probability estimate and calibrated insider-risk indicator are independently verifiable by a relying party against a hardware-vendor attestation service without reliance on the exchange operator, and are consumable as attested input by a downstream regulatory-compliant wrapper system.

### BRIEF DESCRIPTION OF THE DRAWINGS

FIG. 1 depicts the verified prediction confidence scoring system architecture and its trust model, in subfigures FIG. 1A through FIG. 1E.

FIG. 2 depicts the end-to-end scoring method sequence, in subfigures FIG. 2A through FIG. 2E.

FIG. 3 depicts participant historical accuracy profiling and conviction weighting, in subfigures FIG. 3A through FIG. 3E.

FIG. 4 depicts calibrated insider-risk indicator computation, in subfigures FIG. 4A through FIG. 4E.

FIG. 5 depicts signal-weighted aggregation, calibration, and attested export, in subfigures FIG. 5A through FIG. 5E.

### DETAILED DESCRIPTION OF PREFERRED EMBODIMENTS

### Definitions

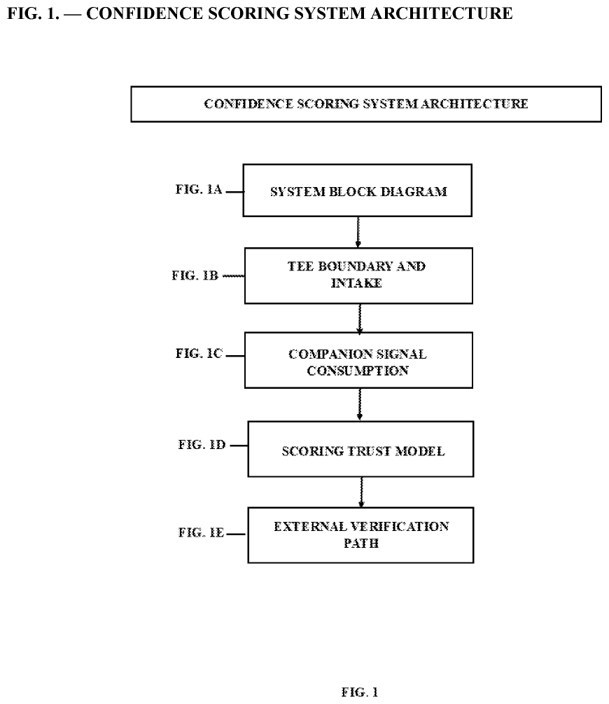

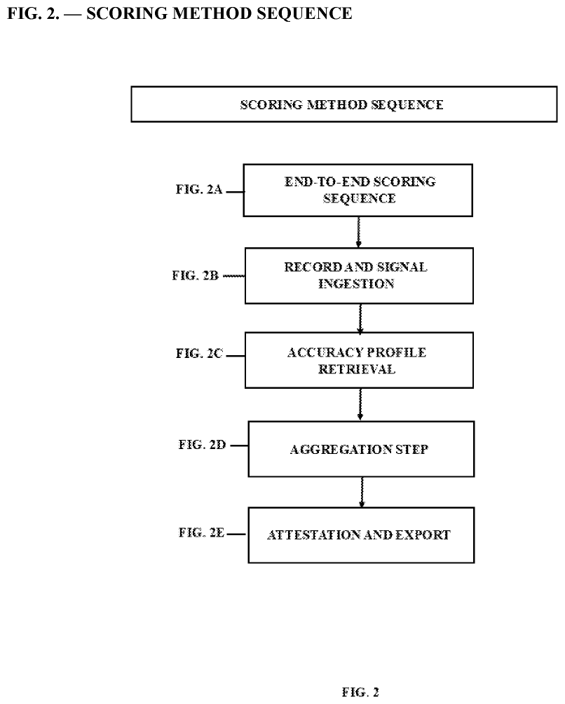

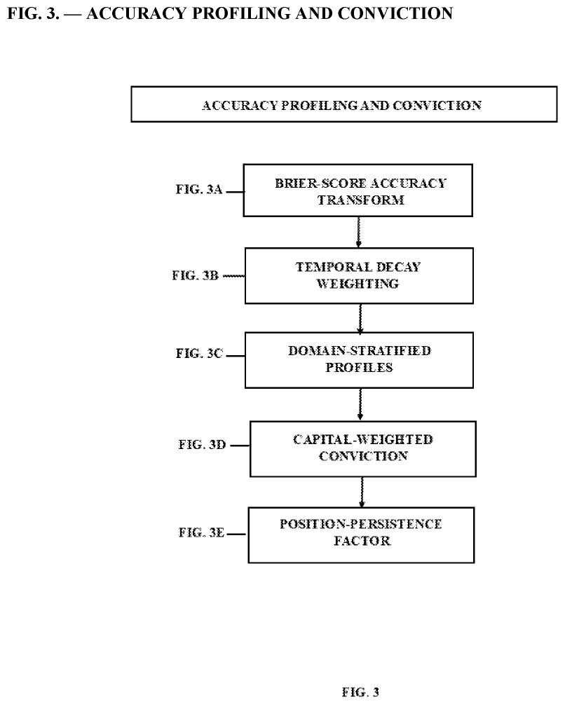

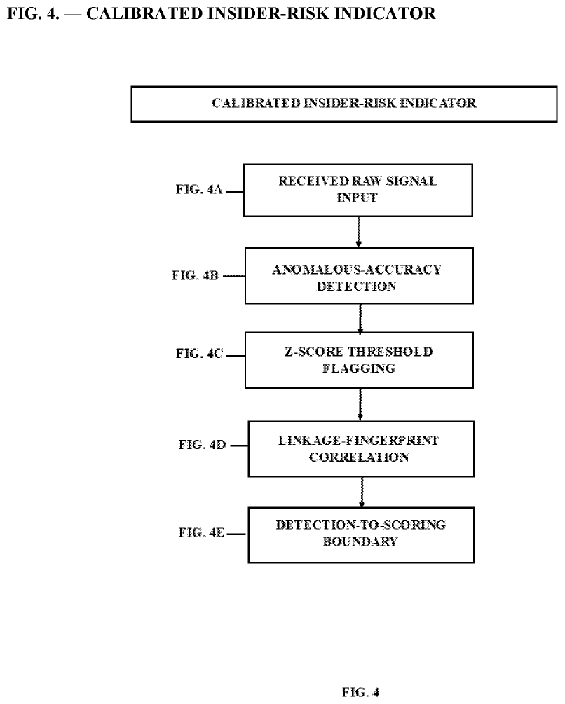

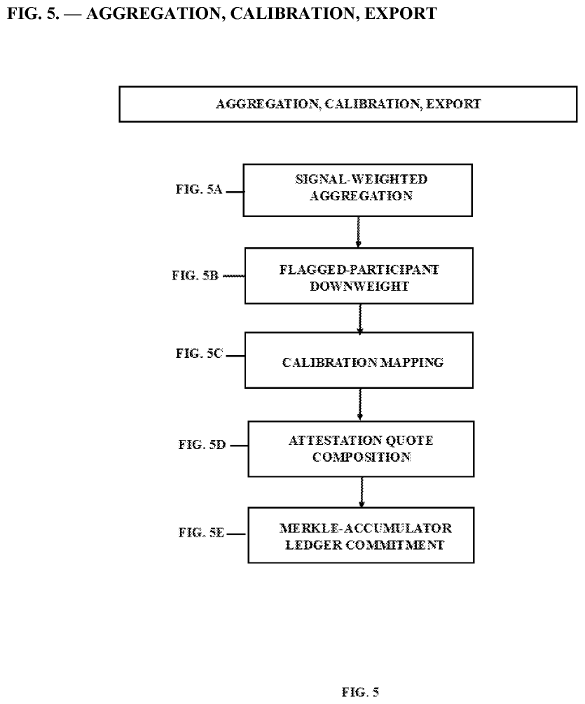

As used herein, the following terms have the meanings set forth below. The definitions are inclusive and non-limiting; each term includes, but is not limited to, the described subject matter.
“Calibrated Insider-Risk Indicator” means a measure computed by the scoring system at a configured z-score threshold from raw trade-integrity signals received from a companion detection system and from anomalous-accuracy patterns, the indicator being computed by the scoring system and not by the companion detection system.
“Capital-Weighted Conviction Score” means a score computed for a participant and contract from position records reflecting committed capital and position persistence, including but not limited to a bounded ratio of committed capital on a contract to total committed capital scaled by a position-persistence factor.
“Historical Accuracy Profile” means a stored, sealed record of a participant's predictive accuracy, including but not limited to a higher-is-better transformed measure equal to one minus a normalized mean Brier score computed on temporally decay-weighted resolution events, optionally stratified by contract domain.
“Hardware Measurement Register” means a hardware-protected register whose contents cryptographically bind to a measured code base upon instantiation, including but not limited to platform configuration registers and equivalent measurement facilities.
“Hardware-Rooted Attestation Key” means a cryptographic key provisioned by a hardware vendor used to sign attestation quotes verifiable against a hardware-vendor attestation service, including but not limited to keys underlying Intel, AMD, ARM, or IBM attestation infrastructures.
“Insider-Risk Module” means a component executing within the hardware trusted execution environment configured to compute the calibrated insider-risk indicator from received raw trade-integrity signals and anomalous-accuracy patterns.
“Raw Trade-Integrity Signal” means a signal received as attested input from a companion hardware-attested trade integrity system, including but not limited to account-linkage fingerprints and wash-trading, coordinated-trading, or collusion indicators, generated by the companion system and not by the scoring system.
“Signal-Weighted Probability Estimate” means a probability estimate for a prediction market contract computed by aggregating participant directional positions weighted by historical accuracy and capital-weighted conviction and downweighted for participants flagged by the calibrated insider-risk indicator.
“Scoring Module” means a component executing within the hardware trusted execution environment configured to aggregate accuracy profiles, conviction scores, and the calibrated insider-risk indicator into the signal-weighted probability estimate.
“Trusted Execution Environment (TEE)” means a hardware-protected execution environment providing measurement, isolation, and remote attestation, including but not limited to Intel SGX, Intel TDX, AMD SEV-SNP, ARM CCA, and IBM Secure Execution.
I. System Architecture Overview. FIG. 1 depicts a verified prediction confidence scoring system organized around a scoring engine executing within a hardware trusted execution environment, comprising an intake interface, a participant-profiling module, a conviction-weighting module, an insider-risk module, a scoring module, a calibration module, and an attestation module (FIG. 1A). Participant position records, participant-identity records, and raw trade-integrity signals from a companion HATIS detection system are delivered into the enclave over encrypted channels terminating within the TEE boundary, with plaintext isolation from the host (FIG. 1B-1C). The trust model comprises the hardware measurement register, the hardware-rooted attestation key, sealed historical accuracy profiles, committed scoring and calibration parameters, and the hardware-vendor attestation service as external trust anchor (FIG. 1D-1E).
II. Intake and Companion Consumption. The intake interface ingests participant position records and pseudonymized participant-identity records, and receives raw trade-integrity signals as attested input from the companion HATIS system, such that plaintext of the participant-identity records does not exist outside the enclave during a computation interval (FIG. 2B). The scoring system consumes the raw trade-integrity signals and does not generate them.
III. Profiling and Conviction Weighting. The participant-profiling module maintains, in a storage region sealed to the hardware identity of the enclave, historical accuracy profiles for each participant, computed as higher-is-better transformed measures equal to one minus the participant's normalized mean Brier score on temporally decay-weighted resolution events, optionally stratified by contract domain (FIG. 3A-3C). The conviction-weighting module computes a capital-weighted conviction score per participant and contract from position records, scaled by a position-persistence factor (FIG. 3D-3E).
IV. Calibrated Insider-Risk Computation. The insider-risk module computes the calibrated insider-risk indicator at a configured z-score threshold from the raw trade-integrity signals received from the companion HATIS system and from anomalous-accuracy patterns in the historical accuracy profiles, flagging participants whose domain accuracy exceeds a population baseline by more than the configured z-score threshold and whose received account-linkage fingerprints indicate non-independent control (FIG. 4A-4E). This is the scoring side of the detection/scoring division: the companion system detects and generates raw signals; the present system computes the calibrated indicator therefrom.
V. Signal-weighted Aggregation and Calibration. The scoring module aggregates the historical accuracy profiles, the capital-weighted conviction scores, and the calibrated insider-risk indicator into a signal-weighted probability estimate, weighting each participant's directional position by a product of transformed historical accuracy and conviction score and reducing the weighting for participants flagged by the calibrated insider-risk indicator (FIG. 5A-5B). A calibration module applies a committed calibration mapping against historical resolution frequencies (FIG. 5C).
VI. Attestation, Downstream Consumption, and Ledger. The attestation module produces a hardware-attestation quote cryptographically signed by the hardware-rooted attestation key, binding the signal-weighted probability estimate, the calibrated insider-risk indicator, a cryptographic commitment over the ingested records and received raw trade-integrity signals, and a cryptographic commitment over committed scoring and calibration parameters to the hardware measurement register (FIG. 5D). The estimate and indicator are independently verifiable by a relying party against a hardware-vendor attestation service without reliance on the exchange operator, and are consumable as attested input by a downstream regulatory-compliant wrapper system. A tamper-evident methodology ledger organized as a Merkle accumulator records attestation quotes, its root periodically committed to an external public commitment channel (FIG. 5E).

### Enablement Examples

Example 1 (single-exchange Intel SGX scoring). Consider a scoring system executing within an Intel SGX enclave at a regulated prediction market exchange. The enclave loads and measures the scoring code base. The intake interface ingests participant position records and pseudonymized identity records for contract C-1, and receives, as attested input from the companion HATIS system, raw trade-integrity signals including an account-linkage fingerprint grouping participants P-2 and P-5. The participant-profiling module retrieves sealed historical accuracy profiles (P-2 transformed accuracy 0.74 in the contract's domain; P-5, 0.69). The conviction-weighting module computes capital-weighted conviction scores from positions. The insider-risk module computes a calibrated insider-risk indicator at the committed z-score threshold of 3.0, flagging P-2 whose domain accuracy exceeds the population baseline by 3.4 standard deviations and whose received linkage fingerprint indicates non-independent control with P-5. The scoring module aggregates accuracy-and-conviction-weighted directional positions into a signal-weighted probability estimate of 0.63 for C-1, downweighting the flagged P-2/P-5 contributions. The attestation module emits a hardware-attestation quote binding the estimate, the indicator, and commitments over inputs and parameters. A downstream RCW wrapper consumes the attested estimate and indicator; a regulator verifies the quote against the Intel attestation service. The scoring system computes the calibrated indicator; the companion HATIS system, which generated the raw signals, does not.

Confidential-Computation Enforcement Embodiment. In a confidential-computation enforcement embodiment, the signal-weighted probability estimate and the calibrated insider-risk indicator are computed only after the participant position and identity records and the received raw trade-integrity signals are decrypted within the enclave, and no plaintext of those records is written to host memory, persistent storage, or any interface outside the hardware trusted execution environment during the computation interval. The resulting estimate and indicator are bound, by the hardware-attestation quote, to the hardware measurement register and to a commitment over the committed scoring and calibration parameters. An exchange operator that attempts to inflate a probability estimate, suppress an insider-risk flag, or substitute a more favorable input produces a record whose recomputed commitment no longer matches the attested commitment, and verification against the hardware-vendor attestation service fails. The technical effect is a market-confidence determination that is simultaneously computed on confidential participant data, verifiable without disclosure of that data, and tamper-evident against manipulation by the market operator whose market is being scored—a result not achievable by a software-only scoring engine, in which the operating exchange can alter inputs, adjust weights, or suppress insider-risk flags without detection by a relying regulator or institutional consumer.

Example 2 (confidential-VM scoring with bound calibration mapping). Consider the system executing within an AMD SEV-SNP confidential virtual machine and consuming raw trade-integrity signals from a companion HATIS instance attested under AMD's attestation service. For a contract C-2, no participant is flagged by the calibrated insider-risk indicator, and the scoring module produces a signal-weighted probability estimate together with a calibration record mapping the raw aggregate to a calibrated probability against historical resolution frequencies. The attestation module binds the estimate, the empty insider-risk flag set, and the committed calibration mapping version into the hardware-attestation quote. A downstream institutional consumer verifies the quote against the AMD attestation service and, because the calibration mapping version is bound into the quote, confirms which calibration methodology produced the estimate, without instantiating a trusted execution environment of its own and without reliance on the exchange operator.

VII. Alternative Embodiments. The system may be practiced on any computer hardware providing the trusted-execution-environment properties described herein, and supports additional and successor TEE implementations and multi-vendor attestation. The accuracy-profiling, conviction-weighting, and calibration methodologies are illustrative and non-limiting. The disclosure herein supports, and the applicant reserves the right to pursue in one or more continuation or divisional applications, claims of broader or differing scope, including without limitation claims directed to hardware-attested signal-weighted scoring of regulated electronic markets generally and claims directed to the calibrated insider-risk computation independent of the prediction-market context. The foregoing embodiments are illustrative and non-limiting.

What is claimed is:

1. A verified prediction confidence scoring system for a regulated prediction market exchange, comprising: at least one scoring engine configured to execute within a hardware trusted execution environment having a hardware measurement register and a hardware-rooted attestation key provisioned by a hardware vendor, the hardware trusted execution environment configured to load a measured scoring code base such that the contents of the hardware measurement register cryptographically bind to the loaded code base upon instantiation; an intake interface configured to ingest into the hardware trusted execution environment, over encrypted channels terminating at endpoints within the hardware trusted execution environment, participant position records, participant-identity records, and raw trade-integrity signals comprising account-linkage fingerprints and trade-pattern indicators received as attested input from a companion hardware-attested trade integrity system, wherein participant-identity records comprise pseudonymized identifiers derived from cryptographic hashes of know-your-customer attestation data and plaintext of said records does not exist outside the hardware trusted execution environment during a computation interval; a participant-profiling module executing within the hardware trusted execution environment and configured to maintain, in a storage region sealed to the hardware identity of the hardware trusted execution environment, historical accuracy profiles for each participant, wherein accuracy scores are stored as higher-is-better transformed measures equal to one minus each participant's normalized mean Brier score computed on temporally decay-weighted resolution events; a conviction-weighting module executing within the hardware trusted execution environment and configured to compute, for each participant and contract, a capital-weighted conviction score from the participant position records; an insider-risk module executing within the hardware trusted execution environment and configured to compute a calibrated insider-risk indicator at a configured z-score threshold from the raw trade-integrity signals received from the companion hardware-attested trade integrity system and from anomalous-accuracy patterns in the historical accuracy profiles, the insider-risk module computing said calibrated insider-risk indicator that the companion hardware-attested trade integrity system does not compute; a scoring module executing within the hardware trusted execution environment and configured to aggregate the historical accuracy profiles, the capital-weighted conviction scores, and the calibrated insider-risk indicator into a signal-weighted probability estimate for each prediction market contract, the signal-weighted probability estimate downweighting contributions of participants flagged by the calibrated insider-risk indicator; and an attestation module configured to produce a hardware-attestation quote cryptographically signed by the hardware-rooted attestation key and binding the signal-weighted probability estimate, the calibrated insider-risk indicator, a cryptographic commitment over the ingested records and received raw trade-integrity signals, and a cryptographic commitment over committed scoring and calibration parameters to the contents of the hardware measurement register, wherein the signal-weighted probability estimate and the calibrated insider-risk indicator are computed over participant position and identity data that does not exist in plaintext outside the hardware trusted execution environment during the computation interval and are cryptographically bound such that the operator of the prediction market exchange cannot manipulate the signal-weighted probability estimate or substitute an ingested input without invalidating verification of the hardware-attestation quote, and wherein the signal-weighted probability estimate and the calibrated insider-risk indicator are independently verifiable by a relying party against a hardware-vendor attestation service without participation of, or reliance on representations by, an operator of the prediction market exchange.

2. A method of producing a hardware-attested signal-weighted probability estimate for a regulated prediction market exchange, the method comprising: loading a measured scoring code base into a hardware trusted execution environment having a hardware measurement register and a hardware-rooted attestation key, such that the contents of the hardware measurement register cryptographically bind to the loaded code base upon instantiation; ingesting, into the hardware trusted execution environment over encrypted channels terminating at endpoints within the hardware trusted execution environment, participant position records, participant-identity records, and raw trade-integrity signals received as attested input from a companion hardware-attested trade integrity system, wherein plaintext of the participant-identity records does not exist outside the hardware trusted execution environment during a computation interval; maintaining, in a storage region sealed to the hardware identity of the hardware trusted execution environment, historical accuracy profiles for each participant, wherein accuracy scores are stored as higher-is-better transformed measures equal to one minus each participant's normalized mean Brier score computed on temporally decay-weighted resolution events; computing, within the hardware trusted execution environment, a capital-weighted conviction score for each participant and contract from the participant position records; computing, within the hardware trusted execution environment, a calibrated insider-risk indicator at a configured z-score threshold from the raw trade-integrity signals received from the companion hardware-attested trade integrity system and from anomalous-accuracy patterns in the historical accuracy profiles, said calibrated insider-risk indicator not being computed by the companion hardware-attested trade integrity system; aggregating, within the hardware trusted execution environment, the historical accuracy profiles, the capital-weighted conviction scores, and the calibrated insider-risk indicator into a signal-weighted probability estimate for each prediction market contract, the aggregating downweighting contributions of participants flagged by the calibrated insider-risk indicator; producing, within the hardware trusted execution environment, such that the signal-weighted probability estimate is computed over data that does not exist in plaintext outside the hardware trusted execution environment and cannot be manipulated by the exchange operator without invalidating verification, a hardware-attestation quote cryptographically signed by the hardware-rooted attestation key and binding the signal-weighted probability estimate, the calibrated insider-risk indicator, and cryptographic commitments over the ingested records, the received raw trade-integrity signals, and committed scoring and calibration parameters to the contents of the hardware measurement register; and exporting the signal-weighted probability estimate, the calibrated insider-risk indicator, and the hardware-attestation quote in a form independently verifiable by a relying party against a hardware-vendor attestation service without participation of, or reliance on representations by, an operator of the prediction market exchange.

3. A non-transitory computer-readable medium storing program instructions that, when executed within a hardware trusted execution environment of a computer system having a hardware measurement register and a hardware-rooted attestation key, cause the hardware trusted execution environment to perform operations comprising: loading a measured scoring code base such that the contents of the hardware measurement register cryptographically bind to the loaded code base upon instantiation; ingesting participant position records, participant-identity records, and raw trade-integrity signals received as attested input from a companion hardware-attested trade integrity system over encrypted channels terminating at endpoints within the hardware trusted execution environment; maintaining historical accuracy profiles in a storage region sealed to the hardware identity of the hardware trusted execution environment; computing a calibrated insider-risk indicator at a configured z-score threshold from the received raw trade-integrity signals and from anomalous-accuracy patterns in the historical accuracy profiles, said calibrated insider-risk indicator not being computed by the companion hardware-attested trade integrity system; aggregating the historical accuracy profiles, capital-weighted conviction scores, and the calibrated insider-risk indicator into a signal-weighted probability estimate downweighting participants flagged by the calibrated insider-risk indicator; and producing, such that the signal-weighted probability estimate is computed over data that does not exist in plaintext outside the hardware trusted execution environment and is tamper-evidently bound against manipulation by the exchange operator, a hardware-attestation quote cryptographically signed by the hardware-rooted attestation key binding the signal-weighted probability estimate, the calibrated insider-risk indicator, and cryptographic commitments over the ingested records and committed parameters to the contents of the hardware measurement register, independently verifiable against a hardware-vendor attestation service without participation of, or reliance on representations by, an operator of the prediction market exchange, wherein any modification of the ingested records, the received raw trade-integrity signals, the committed parameters, or the signal-weighted probability estimate invalidates verification of the hardware-attestation quote.

4. The system of claim 1, wherein the hardware trusted execution environment comprises at least one of Intel Software Guard Extensions, Intel Trust Domain Extensions, AMD Secure Encrypted Virtualization with Secure Nested Paging, ARM Confidential Compute Architecture, IBM Secure Execution for Linux, or any equivalent or successor confidential computing architecture providing hardware-rooted measurement, isolation, and remote attestation.

5. The system of claim 1, wherein the participant-profiling module is configured to maintain domain-stratified historical accuracy profiles, partitioning each participant's resolution history by contract domain and computing a separate higher-is-better transformed accuracy measure per domain, such that the signal-weighted probability estimate for a contract weights each participant's contribution by that participant's accuracy in the domain of the contract.

6. The system of claim 1, wherein the insider-risk module computes the calibrated insider-risk indicator by flagging participants whose domain accuracy exceeds a population baseline by more than the configured z-score threshold and whose account-linkage fingerprints, received from the companion hardware-attested trade integrity system, indicate non-independent control, the calibrated insider-risk indicator being computed by the scoring system and not by the companion hardware-attested trade integrity system, and the raw trade-integrity signals being generated by the companion system and not by the scoring system.

7. The system of claim 1, further comprising a calibration module executing within the hardware trusted execution environment and configured to apply a committed calibration mapping to the aggregated estimate such that the signal-weighted probability estimate is calibrated against historical resolution frequencies, the committed calibration mapping version being bound into the hardware-attestation quote.

8. The system of claim 1, wherein the conviction-weighting module computes the capital-weighted conviction score as a bounded ratio of a participant's committed capital on a contract to that participant's total committed capital across open contracts, scaled by a position-persistence factor, such that transient or nominal positions receive lower conviction weight than persistent capital-backed positions.

9. The system of claim 1, further comprising a tamper-evident methodology ledger configured to receive, under control of the hardware trusted execution environment, append-only records comprising hardware-attestation quotes and methodology disclosure records, organized as a Merkle accumulator whose root is periodically committed to an external public commitment channel comprising at least one of a public blockchain, a regulator-operated commitment endpoint, and a consortium-operated commitment channel.

10. The system of claim 1, wherein the scoring module is configured to compute the signal-weighted probability estimate as a normalized weighted aggregation in which each participant's directional position is weighted by a product of that participant's transformed historical accuracy, the participant's capital-weighted conviction score, and a factor that is reduced for participants flagged by the calibrated insider-risk indicator.

11. The method of claim 2, wherein the aggregating further comprises weighting each participant's directional position by a product of the participant's domain-stratified transformed historical accuracy and the participant's capital-weighted conviction score, and reducing said weighting for participants flagged by the calibrated insider-risk indicator.

12. The method of claim 2, wherein for prediction market contracts having resolved, the maintaining further comprises updating each contributing participant's historical accuracy profile based on the realized resolution outcome under a temporal decay weighting, such that recently resolved events influence the accuracy profile more than temporally distant events.

13. The method of claim 2, wherein the aggregating comprises computing the signal-weighted probability estimate entirely within the hardware trusted execution environment as a normalized aggregation in which each participant's directional position is weighted by a product of (i) that participant's higher-is-better transformed historical accuracy equal to one minus a normalized mean Brier score computed on temporally decay-weighted resolution events, (ii) that participant's capital-weighted conviction score, and (iii) a downweighting factor that is reduced for participants flagged by the calibrated insider-risk indicator computed at the configured z-score threshold from the raw trade-integrity signals received from the companion hardware-attested trade integrity system, and binding the resulting signal-weighted probability estimate and the committed scoring parameters into the hardware-attestation quote, such that the scoring aggregation is verifiable as having been executed by the measured scoring code base on the attested inputs and cannot be reproduced or altered outside the hardware trusted execution environment without invalidating the quote.

14. The method of claim 2, further comprising generating and exporting, together with the hardware-attestation quote, a zero-knowledge proof attesting that the signal-weighted probability estimate was computed by the committed scoring code base under the committed scoring and calibration parameters on the committed inputs, without disclosing per-participant position or identity data.

15. The non-transitory computer-readable medium of claim 3, wherein the operations further comprise computing the calibrated insider-risk indicator from the raw trade-integrity signals received from the companion hardware-attested trade integrity system, the operations not generating said raw trade-integrity signals, such that detection of raw trade-integrity signals is performed by the companion system and computation of the calibrated insider-risk indicator is performed by the scoring system.

16. The non-transitory computer-readable medium of claim 3, wherein the signal-weighted probability estimate and the calibrated insider-risk indicator are computed only after the participant position and identity records and the received raw trade-integrity signals are decrypted within the hardware trusted execution environment, no plaintext of said records exists at any infrastructure outside the hardware trusted execution environment during the computation interval, and the resulting estimate and indicator are bound by the hardware-attestation quote to the hardware measurement register and to a commitment over the committed scoring and calibration parameters, such that the scoring produces a tamper-evident probability determination verifiable by a relying party without the relying party accessing the underlying confidential participant data and invalidated by any post-computation alteration of the inputs, parameters, or estimate by any party including the exchange operator.

17. The non-transitory computer-readable medium of claim 3, wherein the signal-weighted probability estimate, the calibrated insider-risk indicator, and the hardware-attestation quote are formatted such that a relying party comprising a market regulator or a downstream institutional consumer verifies the hardware-attestation quote against a hardware-vendor attestation service and confirms that the signal-weighted probability estimate and the calibrated insider-risk indicator were produced by the measured scoring code base on the attested inputs, without participation of, or reliance on representations by, the operator of the prediction market exchange and without the relying party instantiating a hardware trusted execution environment at infrastructure of the relying party.

18. The non-transitory computer-readable medium of claim 17, wherein the hardware-attestation quote comprises: (a) the contents of the hardware measurement register; (b) a hardware-vendor-signed chain-of-trust certificate; (c) a cryptographic commitment over the ingested participant position and identity records and the received raw trade-integrity signals; (d) the signal-weighted probability estimate; (e) the calibrated insider-risk indicator and the configured z-score threshold; (f) a cryptographic commitment over the committed scoring and calibration parameters; and (g) a signature produced using the hardware-rooted attestation key.

19. The non-transitory computer-readable medium of claim 3, wherein the operations further comprise providing the signal-weighted probability estimate, the calibrated insider-risk indicator, and the hardware-attestation quote to a downstream regulatory-compliant wrapper system that consumes the calibrated insider-risk indicator and the signal-weighted probability estimate as attested input to a capital treatment or compliance determination, the downstream system relying upon the independently verifiable hardware-attestation quote without reliance on representations of the prediction market exchange operator.

20. The non-transitory computer-readable medium of claim 3, wherein the operations further comprise updating the historical accuracy profiles upon resolution events under a temporal decay weighting, and wherein the hardware-attestation quote cannot be reproduced outside the hardware trusted execution environment without invalidating the quote and any modification to a received raw trade-integrity signal or an ingested record outside the scoring system invalidates the hardware-attestation quote.
